(19) United States
(12) Patent Application Publication
(10) Pub. No.: US 2009/0183434 A1
(43) Pub. Date: Jul. 23, 2009

(54) VEHICLE GLAZING

(75) Inventor: Jussi Pekka Puotunen, Uusikaupunki (FI)

Correspondence Address: BUCHANAN, INGERSOLL & ROONEY PC, POST OFFICE BOX 1404, ALEXANDRIA, VA, 22313-1404, US

(73) Assignee: PILKINGTON AUTOMOTIVE FINLAND OY, Tampere 10 (FI)

(21) Appl. No.: 12/303,163

(22) PCT Filed: Jun. 7, 2007
(86) PCT No.: PCT/EP07/55619

§ 371 Date: Mar. 6, 2009

(30) Foreign Application Priority Data
Jun. 9, 2006 (GB) 0611328.6

(51) Int. Cl. E05D 15/10; E05F 11/06; E05D 11/00; E05F 11/38

(52) U.S. Cl. 49/209; 49/360; 16/223; 49/348

(57) ABSTRACT

The present invention relates to vehicle glazing, in particular to sliding windows for land vehicles such as buses, trams and trains, in particular slow speed trains. A sliding window for a land vehicle, comprising a fixed glazing panel defining an opening therein, a moving glazing panel, an opening mechanism attached to the moving glazing panel for moving the moving glazing panel between a closed position, at which the moving glazing panel is received in the opening and substantially coplanar with the fixed glazing panel, and an open position, at which the moving glazing panel is laterally spaced inwardly relative to the opening, and a slider assembly, including upper and lower horizontal slider rails disposed along the inside face of the fixed glazing panel, for moving the moving glazing panel horizontally along the fixed glazing panel in spaced relation thereto between the open position and a displaced position, at which the moving glazing panel is longitudinally spaced relative to the opening, wherein the opening mechanism comprises an articulated mechanism connecting the upper edge of the moving glazing panel to the upper slider rail and a sliding mechanism connecting the lower edge of the moving glazing panel to the lower slider rail. Safety devices for openable vehicle windows are also disclosed.

The present invention relates to vehicle glazing, in particular to sliding windows for land vehicles such as buses, trams and trains, in particular slow speed trains. The present invention also relates to an openable vehicle window incorporating a safety device for mounting the movable glazing, which may be sliding or hinged, of a vehicle window to the vehicle bodywork.

It is known to provide openable side windows for land vehicles such as buses, trams and trains, in particular slow speed trains. Such windows may have a moving glazing adjacent to a fixed glazing, and the moving glazing may be articulated or hinged, or sliding, relative to the fixed glazing.

Known sliding windows, particularly for buses, are provided to enable the driver to slide open a slidable glazing panel adjacent to him, for example for ventilation or to permit him to put his arm through the opening e.g. to pay a toll. Such known sliding windows typically have a generally rectangular sliding glazing disposed within a larger fixed glazing that is affixed around its periphery to the vehicle bodywork. The sliding glazing is mounted for horizontal movement at its upper and lower edges to respective upper and lower horizontal rails that extend along the upper and lower edges and are affixed either to the fixed glazing or, more preferably for safety reasons, to the vehicle bodywork. Stops are provided for limiting the extent of opening of the sliding glazing. A locking mechanism, incorporating a catch, is disposed at one upright edge of the sliding glazing, usually in the forward direction of movement of the vehicle. Manual release of the locking mechanism permits the sliding glazing to be released from its closed locked position and slid to an open position. The sliding glazing can be slid selectively a desired distance, up to the maximum distance defined by the stops, to open the sliding glazing a desired extent.

Some known horizontal rail mechanisms tend to suffer from the problem that the sliding mechanism and/or the sliding surfaces, particularly for the lower rail, are exposed. This is not aesthetically acceptable in modern vehicles. Also, this can lead the sliding mechanism and/or the sliding surfaces being liable to soiling by trapped dirt, or coated by liquid such as rainwater when the window is open, that can degrade the sliding performance.

There is a need in the art, particularly for modern sliding bus windows, for the window to be mounted flush with the vehicle body, and for the moving sliding glazing to be completely surrounded by the fixed glazing and flush with the fixed glazing in the closed position in the opening of the fixed glazing.

Known mounting arrangements for modern sliding bus windows provide mechanisms for permitting the moving sliding glazing to be movable out of and into the plane of the fixed glazing when opening and closing, respectively, the sliding window.

The known mechanisms typically provide mounts for the moving sliding glazing to enable at least one of the edges of the moving sliding glazing initially during the opening operation to be movable relative to the plane of the fixed glazing. The mounts may comprise horizontal ramps, or articulating mounts that are rotatable about a vertical axis or a horizontal axis.

When the mounts comprise horizontal ramps, typically the rear vertical edge of the moving sliding glazing is slid horizontally and moved inwardly by engagement with the ramps. Then the moving sliding glazing is moved out of the plane of the fixed glazing as it is slid backwardly. Such an arrangement is disclosed in EP-A-0778168, for example. This can require a large initial force to move the glazing over the ramp surfaces. The exposed ramp surfaces can become soiled and the sliding mechanism can be difficult to operate.

When the mounts comprise articulating mounts that are rotatable about a vertical axis, as disclosed for example in EP-A-0683064, the device can have a complicate structure and be difficult to operate, and again can be subject to soiling of exposed sliding surfaces.

When the mounts comprise articulating mounts that are rotatable about a horizontal axis, as disclosed for example in DE-A-10301584 and EP-B-0857844, the upper and lower articulating mechanisms can be complicated in construction and difficult to operate. Sometimes a large force is required to lift the window to push or pull the moving sliding glazing out of the plane of the fixed glazing. The articulating mounts and rails are also exposed and subject to soiling as discussed above.

In one aspect, the present invention aims at least partially to obviate or overcome one or more of these problems of known sliding vehicle windows.

Such known openable side windows for land vehicles such as buses, trams and trains, in particular slow speed trains may incorporate a safety device for supporting the moving glazing, and its fittings, in the event that the fixed glazing breaks. Typically the fittings of the moving glazing are affixed to the body of the vehicle by the safety device. Some known safety devices are complicated and difficult to fit, and are aesthetically deficient.

In EP-A-0778168 the ends to the fittings of the moving glazing are sandwiched between the fixed glazing and the body of the vehicle. In EP-A-1527920 and FR-A-2787498 complicated safety devices are additionally provided which interconnect plural parts of the openable window.

In another aspect, the present invention aims at least partially to obviate or overcome one or more of these problems of known safety devices for openable vehicle windows.

Accordingly, in one aspect the present invention provides sliding window for a land vehicle, comprising a fixed glazing panel defining an opening therein, a moving glazing panel, an opening mechanism attached to the moving glazing panel for moving the moving glazing panel between a closed position, at which the moving glazing panel is received in the opening and substantially coplanar with the fixed glazing panel, and an open position, at which the moving glazing panel is laterally spaced inwardly relative to the opening, and a slider assembly, including upper and lower horizontal slider rails disposed along the inside face of the fixed glazing panel, for moving the moving glazing panel horizontally along the fixed glazing panel in spaced relation thereto between the open position and a displaced position, at which the moving glazing panel is longitudinally spaced relative to the opening, wherein the opening mechanism comprises an articulated mechanism connecting the upper edge of the moving glazing panel to the upper slider rail and a sliding mechanism connecting the lower edge of the moving glazing panel to the lower slider rail.

In another aspect the present invention further provides an openable window for a land vehicle, comprising a fixed glazing panel defining an opening therein, a moving glazing panel, a moving mechanism attached to the moving glazing panel, the moving glazing panel being movable by said moving mechanism between a closed position, at which the moving glazing panel is received in the opening and substantially coplanar with the fixed glazing panel, and an open position, and a safety device for supporting the moving glazing panel and the moving mechanism in the event of breakage of the fixed glazing panel, the safety device comprising a first connector fixed to the moving mechanism and a second connector located at a periphery of the fixed glazing panel and adapted to be fixed to a body of the vehicle when the window is fitted into a recess in the body of the vehicle, the first and second connectors being cooperatively interconnected.

A further aspect of the present invention provides a window for a land vehicle, comprising a fixed glazing panel defining an opening therein, a moving glazing panel, a moving mechanism attached to the moving glazing panel, the moving glazing panel being movable by said moving mechanism between a closed position, at which the moving glazing panel is received in the opening and substantially coplanar with the fixed glazing panel, and an open position, and a safety device for supporting the moving glazing panel and the slider assembly in the event of breakage of the fixed glazing panel, the safety device comprising at least one element connected between the moving mechanism and a periphery of the fixed glazing panel and adapted to be fixed to a body of the vehicle when the window is fitted into a recess in the body of the vehicle.

Embodiments of the present invention will now be described by way of example only with reference to the accompanying drawings, in which:

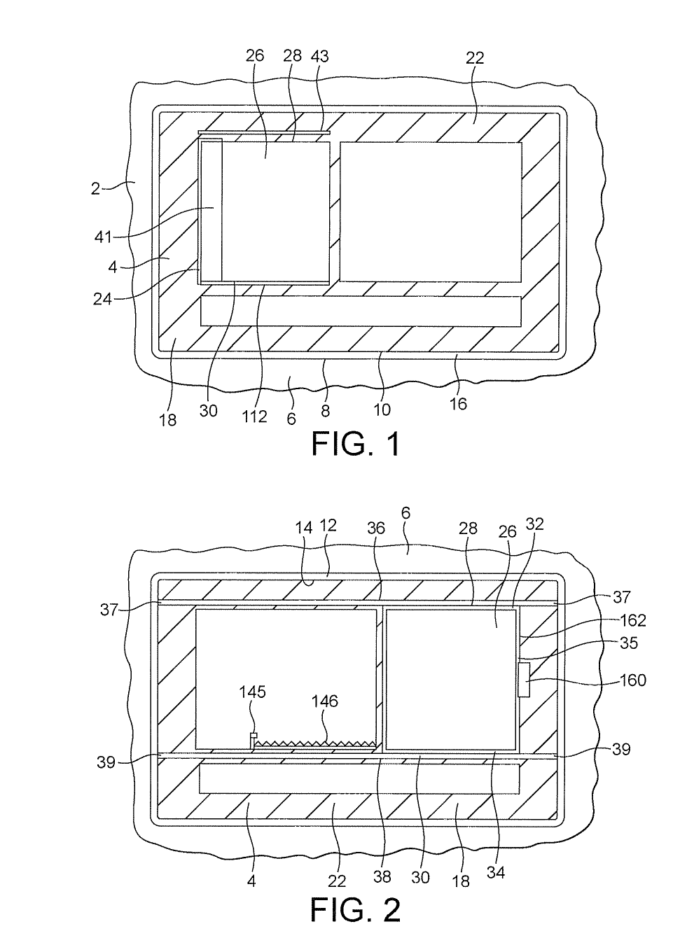

FIG. 1 is a schematic elevation view of part of an outer side of a bus incorporating a sliding window for a vehicle in accordance with a first embodiment of the present invention, the window being in a closed configuration;

FIG. 2 is a schematic elevation view of the inner side of the sliding window of FIG. 1;

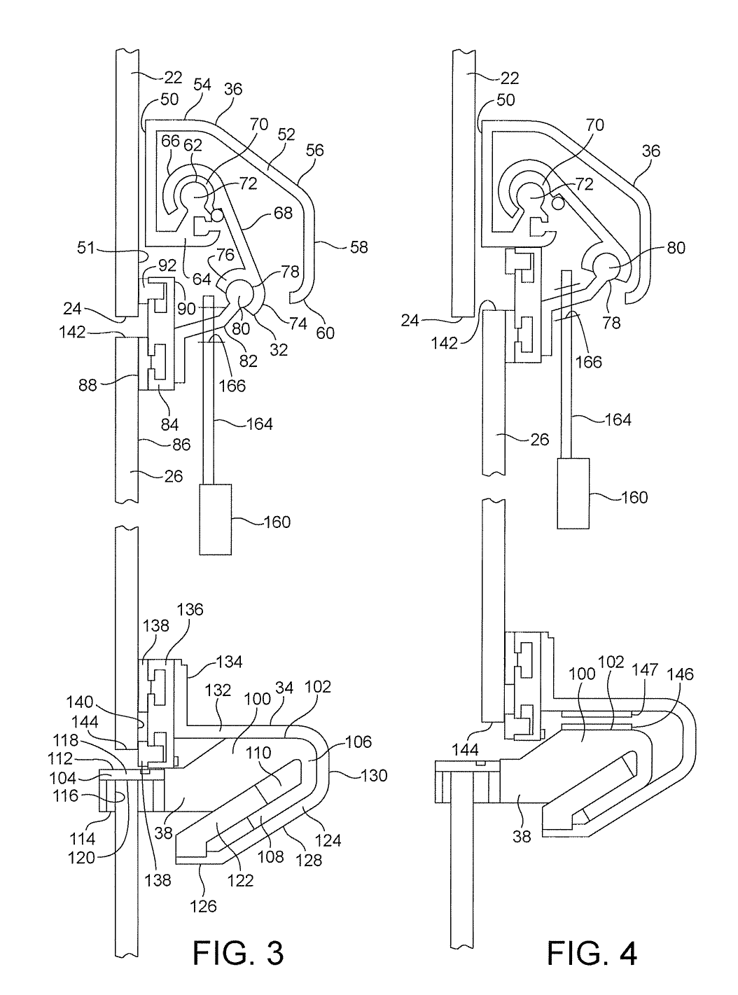

FIG. 3 is a schematic vertical section on line A-A of the sliding window of FIG. 1 in the closed configuration;

FIG. 4 is a schematic vertical section on line A-A of the sliding window of FIG. 1 in an open configuration;

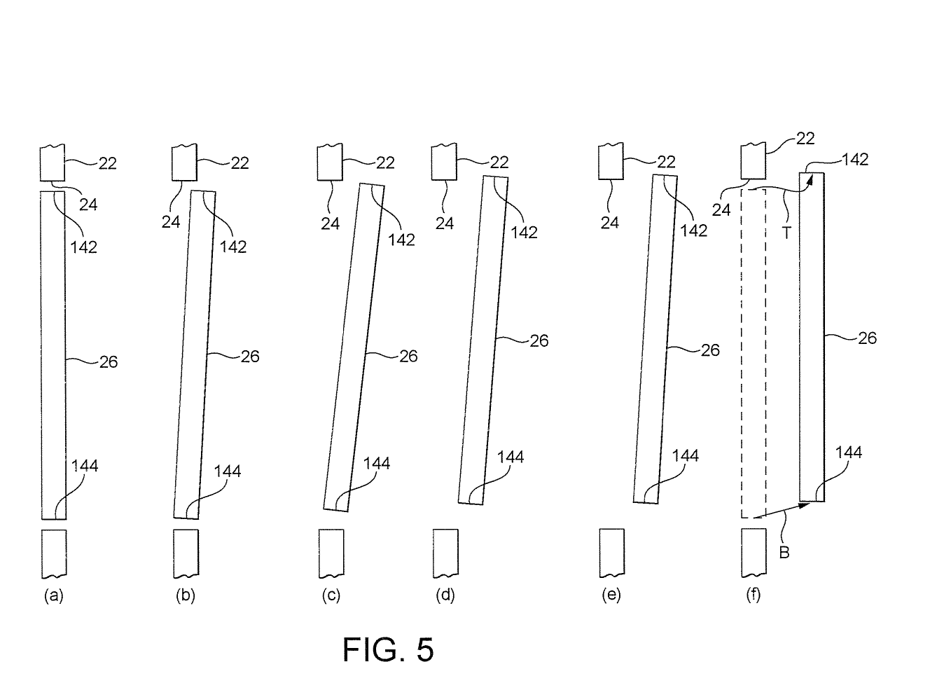

FIGS. 5 (a) to (f) are simplified schematic vertical sections on line A-A of the sliding window of FIG. 1 showing progressive movements of the moving glazing panel from the closed configuration to the open configuration;

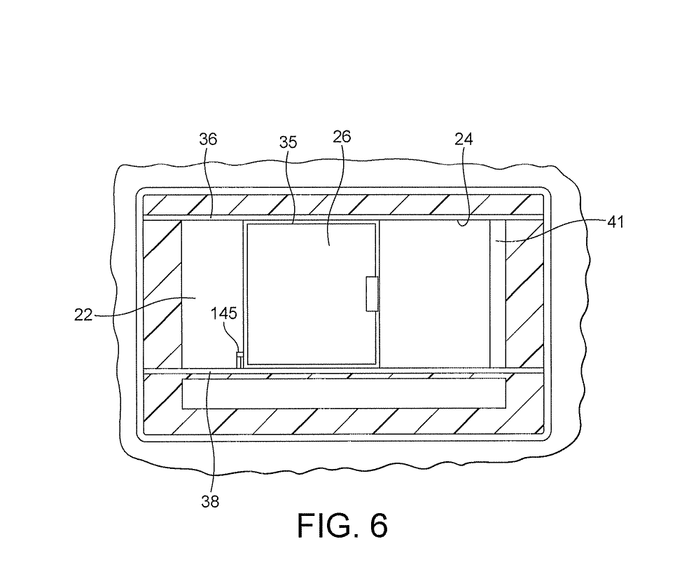

FIG. 6 is a schematic elevation view of the inner side of the sliding window of FIG. 1 with the window in a displaced configuration;

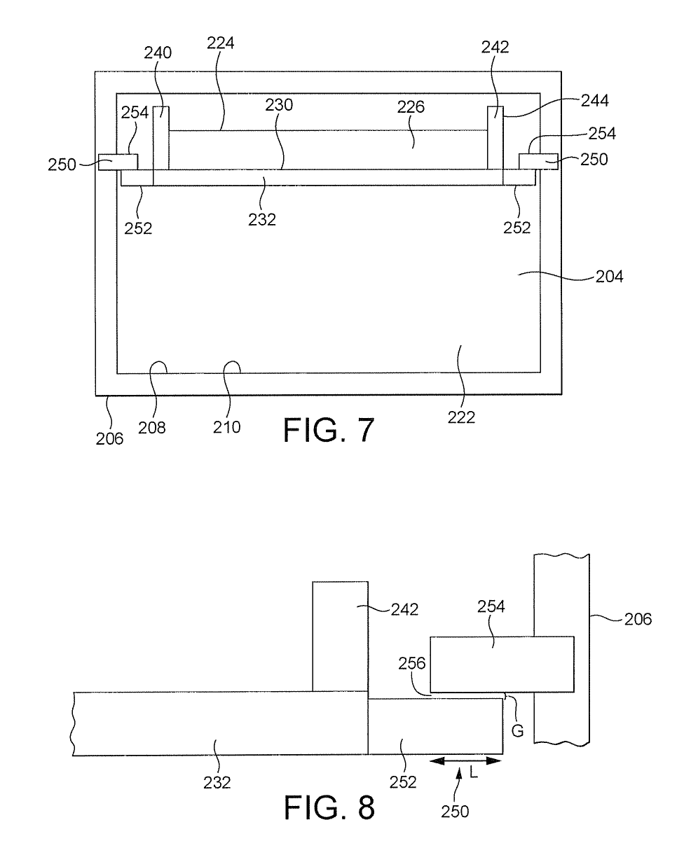

FIG. 7 is a schematic elevation view of a safety device for a movable glazing of a window in accordance with a second embodiment of the present invention;

FIG. 8 is an enlarged schematic elevation view of part of the safety device of FIG. 7;

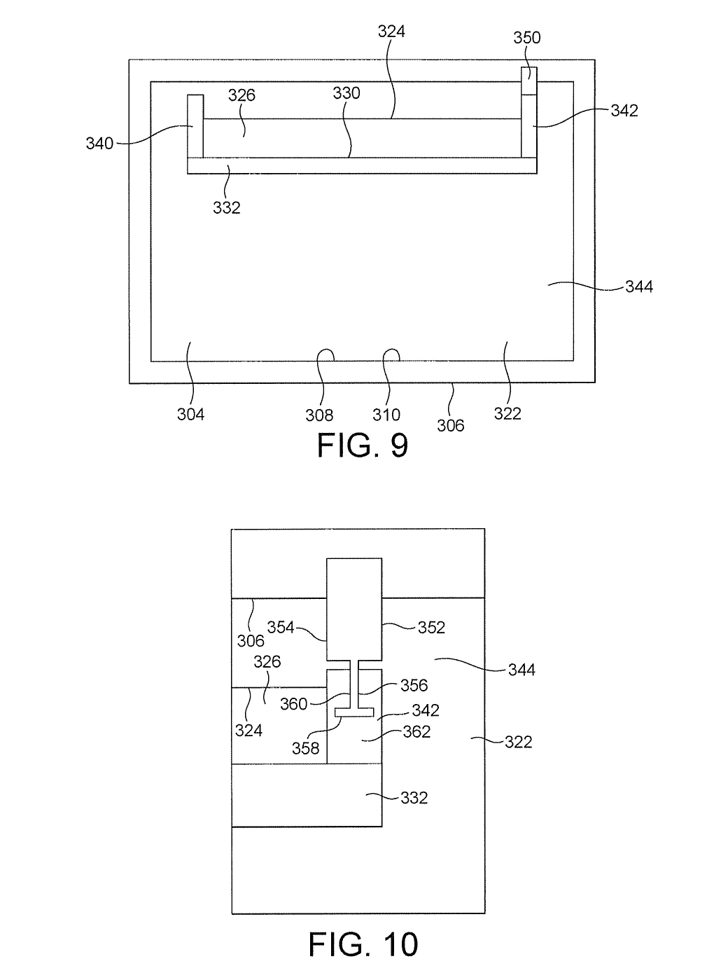

FIG. 9 is a schematic elevation view of a safety device for a movable glazing of a window in accordance with a third embodiment of the present invention;

FIG. 10 is an enlarged schematic elevation view of the safety device of FIG. 9;

FIG. 11 is a schematic elevation view of a safety device for a movable glazing of a window in accordance with a fourth embodiment of the present invention;

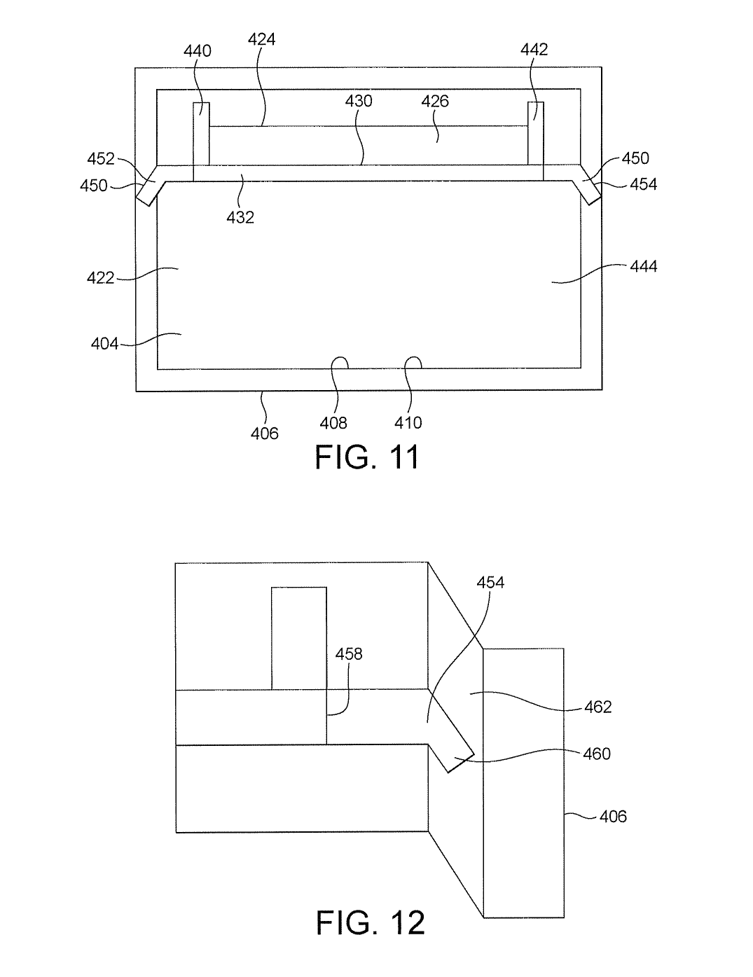

FIG. 12 is an enlarged schematic elevation view of part of the safety device of FIG. 11;

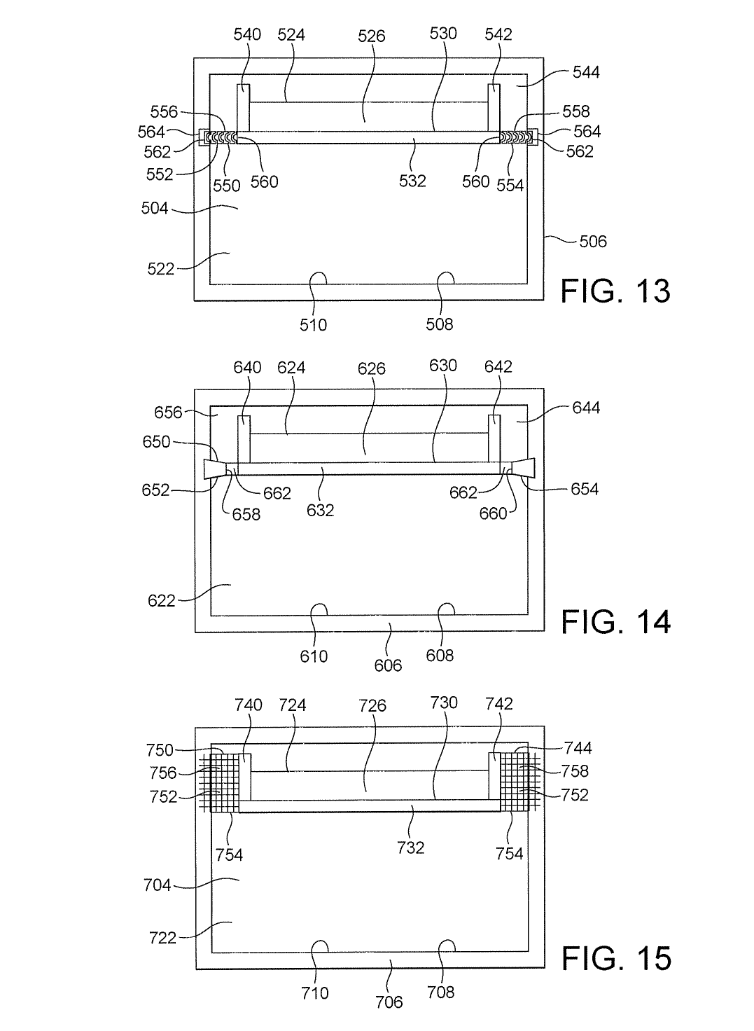

FIG. 13 is a schematic elevation view of a safety device for a movable glazing of a window in accordance with a fifth embodiment of the present invention;

FIG. 14 is a schematic elevation view of a safety device for a movable glazing of a window in accordance with a sixth embodiment of the present invention;

FIG. 15 is a schematic elevation view of a safety device for a movable glazing of a window in accordance with a seventh embodiment of the present invention;

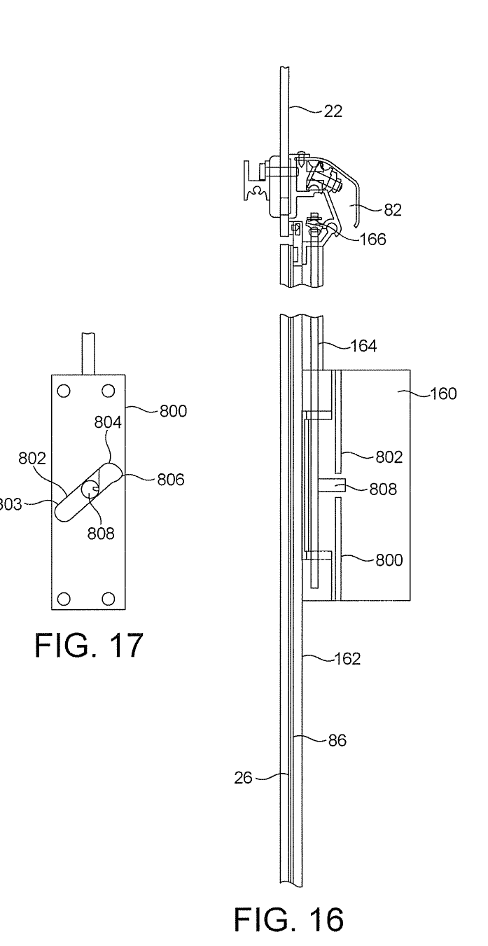

FIG. 16 is a schematic elevation view of a handle structure for a movable glazing for incorporation into a window in accordance with the first embodiment of the present invention; and

FIG. 17 is a schematic elevation view of a part of the handle structure of FIG. 16.

For ease of illustration, in the drawings the dimensions of the various parts of the vehicle windows of the invention are not necessarily shown in proportion. In particular, the thicknesses of various parts may be exaggerated.

Referring to FIGS. 1 and 2, there is shown an outer side of a bus 2 incorporating a sliding window 4 for a vehicle in accordance with a first embodiment of the present invention. The bus 2 has a body 6 providing an elongate recess 8 in which the sliding window 4 is sealingly fitted so as to be substantially flush with the body 6. The window 4 has an outer periphery 10 which is sealed, in known manner, to flanges 12 of the vehicle body 6 which extend inwardly of the recess 8. Typically, a peripheral band 14 of adhesive, such as polyurethane adhesive, bonds an inner face of the window 4 to the flanges 12, and an annular seal 16 of adhesive, such as polyurethane adhesive, surrounds the outer periphery 10 of the window 4, so as to be located between the window 4 and the body 6.

Obscuration bands 18 may be printed, in known manner, on the inner face of the window 4 so as to cover the fittings of the window and to improve the aesthetic appearance of the outside of the vehicle. The obscuration bands 18 also cover the polyurethane adhesive/sealant so as to ensure that it remains flexible and reliably seals the glazings to the vehicle body to prevent water ingress.

The window 4 comprises a fixed glazing panel 22 having an opening 24 therein in which a moving glazing panel 26 is fitted. The fixed glazing panel 22 surrounds the moving glazing panel 26. The moving glazing panel 26 is mounted along upper and lower horizontal edges 28, 30 thereof to upper and lower sliding fittings 32, 34 of a peripheral frame 35 fitted to the inside face of the moving glazing panel 26. The upper and lower sliding fittings 32, 34 are in turn slidably mounted to upper and lower horizontal rails 36, 38 extending along the inside of the fixed glazing panel 22. The upper and lower horizontal rails 36, 38 are typically extruded metal rails, typically of aluminium. The upper and lower horizontal rails 36, 38 may be affixed to the inside face, facing the interior of the vehicle, of the fixed glazing panel 22, for example by adhesive, or by fixing elements such as bolts or screws fitted to a counterplate on the outside face of the fixed glazing panel 22. At their ends 37, 39, the upper and lower horizontal rails 36, 38 may be affixed to the bodywork 6. This provides a safety device supporting the moving glazing panel 26 and its fittings in the event that the fixed glazing panel 22 is broken.

The moving glazing panel 26 can be moved between a closed position which is shown in FIGS. 1 to 3 in which the moving glazing panel 26 is located in the opening 24 and flush (i.e. coplanar) with the fixed glazing panel 22 and an open position which is shown in FIG. 4 in which the moving glazing panel 26 is inwardly recessed towards the interior of the vehicle and is disposed adjacent to the opening 24, and parallel with the fixed glazing panel 22. The moving glazing panel 26 can then be moved from the open position to a displaced position as shown in FIG. 6 by sliding the moving glazing panel 26 horizontally along the rails 36, 38, typically in a rearwardly direction with respect to the vehicle.

In the displaced position the moving glazing panel 26 is not fully adjacent to the opening 24 so that, for example, a driver could put his arm through the opening 24. The moving glazing panel 26 can, in a reverse closing operation, be slid back from the displaced position to the open position, and then, subsequently, moved to the closed position so as to be closed again, if required. The fixed glazing panel 22 and the moving glazing panel 26 are disposed, when the moving glazing panel 26 is closed, in a common vertical plane so that both panels are substantially flush with the vehicle body 6.

The fixed glazing panel 22 may be single or double glazed, as known in the art. The moving glazing panel 26 may also be single or double glazed. Typically, the glazings 22, 26 are composed of toughened glass. Alternatively, the glazings 22, 26 may be composed of laminated glass.

If desired, a wind deflector 41 may be mounted to the fixed glazing panel 22 along the leading vertical edge of the opening 24 and/or an upper horizontal drip deflector 43 may be mounted to the fixed glazing panel 22 above and along the upper horizontal edge of the opening 24.

Referring to FIGS. 3, 4 and 5, the opening/closing mechanism and the sliding mechanism at the inner side of the hinged window 4 of FIG. 1 are shown in greater detail.

FIG. 3 shows the moving glazing panel 26 in the closed position within the opening 24 of the fixed glazing panel 22. Accordingly, the moving glazing panel 26 is co-planar with the fixed glazing panel 22. The upper horizontal rail 36 includes an inner vertical wall 50 disposed adjacent the inside face 51 of the fixed glazing panel 22. An upper cover member 52, integral with the wall 50, extends downwardly and inwardly towards the interior of the vehicle. The upper cover member 52 comprises a horizontal wall portion 54 adjacent to the vertical wall 50, a downwardly inclined portion 56, a vertical skirt portion 58 and a lip portion 60 extending downwardly and rearwardly back towards the fixed glazing panel 22. An elongate horizontal male hinge member 62 is integral with a horizontal wall 64 which is in turn integral with the vertical wall 50. The male hinge member 62 is upwardly directed and is rotatably received within a downwardly directed elongate female hinge portion 66 at one end of an articulated hinge element 68. This defines a first hinge 70 having a first hinge axis 72. The articulated hinge element 68 is typically a metal extrusion, for example of aluminium.

At the other end of the articulated hinge element 68 is provided a second downwardly directed elongate female hinge portion 74 in which is rotatably received an elongate male hinge member 76. This defines a second hinge 78 having a second hinge axis 80. The elongate male hinge member 76 is connected by an arm 82 to an elongate upper mount 84 which is affixed in a horizontal orientation along the upper inside face 86 of the moving glazing panel 26, for example by a layer of adhesive 88. The upper mount 84 extends upwardly to provide a seal portion 90 in which is received an elongate horizontal upper gasket 92, typically of an elastomeric foam, optionally having a central cylindrical cavity so as to be readily compressible. In the closed position, the gasket 92 is urged against the inside face of the fixed glazing panel 22 extending along the upper edge of the opening 24.

The lower horizontal rail 38 concludes a support part 100 which extends inwardly and upwardly to define an upper horizontal support surface 102 which is located relatively inwardly and upwardly with respect to the lower edge 104 of the opening 24 in the fixed glazing panel 22. The support part 100 has an integral downwardly depending skirt 106 at its inner edge thereof and, integral with the skirt 106, there is provided a flange 108 extending downwardly and rearwardly back towards the fixed glazing panel 22. The support part 100, the skirt 106 and the flange 108 together define a downwardly oriented female slider opening 110 which is inclined to the horizontal by an acute angle, typically about 30° to the horizontal.

The support part 100 is mounted to the fixed glazing panel 22 by a hook-like mounting 112 which is affixed to the support part 100 and extends outwardly through the opening 24 and then downwardly to form a hook-like part which is affixed, typically by an adhesive layer 114, to the outer surface of the fixed glazing panel 22 beneath the upper edge of the opening 24. A horizontal portion 118 of the hook-like mounting 112 sits on the upper edge 120 of the fixed glazing panel 22 defining the lower edge of the opening 24 so as to provide a secure vertical mount for the support part 100. The hook-like mounting 112 extends along the width of the opening 24.

A male slider member 122 is received within the inclined elongate female slider opening 110. The male slider member 122 correspondingly comprises an inclined body that extends upwardly and inwardly by an acute angle to the horizontal, typically about 30°. The male slider member 122 is attached to a lower cover member 124 which surrounds and conceals the adjacent outer surfaces of the support part 100, the skirt 106 and the flange 108. The lower cover member 124 comprises a lower horizontal portion 126 affixed to the male slider member 122, an upwardly inclined flange 128 integral therewith, a skirt portion 130 integral therewith, and a frame part 132 integral therewith. The frame part 132 has an integral vertical wall 134 which is affixed to an elongate lower mount 136 which in turn is affixed, typically by a layer of adhesive 138, to the lower inner surface 140 of the moving glazing panel 24. The lower mount 136 includes at its lower edge an elongate horizontal lower gasket 138, similar to the upper gasket 92, which in the closed configuration bears against an upper surface of the hook-like mounting 112.

The male slider member 122, and optionally the entire frame part 132 as well, is typically composed of extruded plastic material. This permits the male slider member 122, to be slid freely, in a low friction manner, relative to the horizontal lower rail 38, including the portions defining the elongate female slider opening 110. Such sliding movement is both upwardly and inwardly at an angle inclined to the horizontal, when moving from the closed to the open position, and also horizontally, when moving from the open position to the displaced positions. The reverse movements occur when closing the window again.

In the closed configuration as shown in FIG. 3, the articulated hinge element 68 is rotated in a clockwise direction downwardly about the first axis 70 and the frame part 132 rests on the upper surface 102 of the support part 100 so as to retain the moving glazing panel 26 co-planar with the fixed glazing panel 22 in the opening 24 thereof. The male slider member 122 is only partially received within the female slider opening 110 and is disposed in a relatively downwardly orientation. The gaskets 92, 138 act to seal the opening 24 against water ingress into the vehicle. Upright members of the frame 35 are provided with corresponding gaskets (not shown) along the two vertical edges of the moving glazing panel 26 on the inside face thereof. This seals the moving glazing panel 26 around its entire periphery when the moving glazing panel 26 is in the closed position.

In order to open the moving glazing panel 26, the moving glazing panel 26 is lifted in an upwardly direction. A handle 160 is mounted on an upright 162 of the frame 35. The handle 162 is rotatable about a vertical axis between two positions, a forwardly directed closed position shown in FIG. 2 and a rearwardly directed open position shown in FIG. 6. The handle 160 is mounted on a vertically oriented rotatable rod 164 that is mounted for rotational movement, via a tiltable joint 166, to the arm 82, as shown in FIGS. 3 and 4. The handle 160 incorporates a releasable locking mechanism that locks together the frame 35 and the fixed glazing panel 22 when the handle 160 is in the forwardly directed closed position shown in FIG. 2. This securely locks the sliding window. Otherwise, it would be possible for a person to open the moving glazing panel 26 merely by applying an upward and inward force from the outside of the vehicle. When it is desired to open the sliding window, the handle 160 is manually rotated to the rearwardly directed open position shown in FIG. 6. This releases the releasable locking mechanism. The handle 160 is then lifted upwardly. This rotates the rod 164 and correspondingly rotates and lifts the arm 82 via the tiltable joint 166. This permits the moving glazing panel 26 to be opened by being lifted upwardly and inwardly.

As shown in FIG. 4, when the moving glazing panel 26 is lifted upwardly and inwardly, this causes the articulated hinge element 68 to rotate in an anticlockwise direction by rotation about the first hinge 70 and the arm 84 to rotate in a clockwise direction by rotation about the second hinge 78. In addition, the male slider member 122 is pulled upwardly and inwardly so as to be wholly received within the female slider opening 110. These two movements cause the moving glazing panel 26 to be moved upwardly and inwardly relative to the opening 24, out of the plane of the fixed glazing panel 22, into the partially open position shown in FIG. 4. In the open position, the moving glazing panel 26 is inwardly spaced relative to the plane of the fixed glazing panel 22, but parallel therewith.

It may be seen from FIGS. 3 and 4 that the top and bottom edges 142, 144 of the moving glazing panel 26 are subjected to different geometrical movements when the moving glazing panel 26 is moved from the closed position to the open position. The top edge 142 is moved as a result of rotation of the articulated hinge element 68 in one rotational direction about the first hinge axis 72 and by the simultaneous rotation of the arm 82 and upper mount 84 in the opposite rotational direction about the second hinge axis 78. The distance between the two hinge axes 70, 78 and the distance between the second hinge axis 80 and the mounting point at the top edge 142 of the moving glazing panel 26 are selected to provide that during the opening operation the top edge 142 moves along a particularly defined arc of movement which is non-circular. In the initial phase of movement, the top edge 142 moves inwardly relatively rapidly and upwardly relatively slowly and in the final phase of movement, conversely the top edge 142 moves inwardly relatively slowly and upwardly relatively rapidly.

In contrast, the bottom edge 144 of the moving glazing panel 26 moves along a linear path in the opening operation, the angle of inclination of the path being determined by the angle of inclination of the male and female slider elements with respect to the horizontal, typically about 30° to the horizontal.

The orientation of the moving glazing panel 26 as it progressively moves from a closed position to the open position is summarised in FIG. 5. FIG. 5(a) shows the moving glazing panel 26 in a closed position within the opening 24 of the fixed glazing panel 22. As shown in FIG. 5(b) as the moving glazing panel 26 is initially opened, the top edge 142 is moved inwardly to a greater extent than the lower edge 144. Then, as shown in FIGS. 5(c) to 5(e), the upper edge 142 moves inwardly relatively quickly and upwardly relatively slowly, whereas the bottom edge 144 has a linear motion upwardly and inwardly. The final part of the opening movement is shown in FIG. 5(e) and in FIG. 5(f) the final open position is shown, the two lines represented by the letters T and B respectively showing the movement of the top and bottom edges 142, 144 from the initial closed position of FIG. 5(a), which is shown in phantom in FIG. 5(f).

The angle of inclination of the moving glazing panel 26 progressively changes during the opening operation. Initially and finally the moving glazing panel 26 is vertical. In the middle of the opening operation the moving glazing panel is at its maximum inclination to the vertical. This provides an elegant and smoothly easy operating mechanism for the moving glazing panel 26.

The provision of an articulated mechanism along the top edge 142 of the moving glazing panel 26 and a linearly sliding mechanism along the bottom edge 144 of the moving glazing panel 26 provides a number of advantages. First, by simple manual pulling of the moving glazing panel 26 inwardly and upwardly, the top edge 142 of the moving glazing panel 26 can relatively quickly be pulled inwardly relative to the fixed glazing panel 22 and this then provides a simple mechanical operation to continue to push the moving glazing panel 26 upwardly until it is in the position parallel to and spaced from the plane of the fixed glazing panel 22. By providing a linearly sliding mechanism along the bottom edge, the opening mechanism is simplified as compared to mechanisms using two articulations, and furthermore can provide a low friction sliding motion for the lower edge of the moving glazing panel, in a simple linear motion.

Furthermore, the use of a male/female construction for achieving the linear movement of the lower edge of the moving glazing panel, permits the entire lower sliding mechanism to be concealed by the lower cover. Not only is this aesthetically pleasing, but also it significantly decreases soiling or entrapment of material within the lower sliding mechanism. The lower cover provides a clean uncluttered upper surface which can easily be wiped down and does not present any moving parts which could be hazardous, for example by entrapment of body parts or clothing for example. The upper cover is similarly configured to conceal the upper articulating mechanism.

Once in the open position as shown in FIG. 4, the entire moving glazing panel 26 can be slid horizontally along the upper and lower horizontal rails 36, 38 to a desired displaced position shown in FIG. 6 where the opening 24 in the fixed glazing panel 22 may be partly or completely free of the moving glazing panel 26. One or more stop members 145 may be provided to limit the extent of horizontal movement of the moving glazing panel 26. After the moving glazing panel 26 has been horizontally slid to open it a desired distance, the upward manual force applied by the user via the handle 160 to lift the moving glazing panel 26 is released, and then the moving glazing panel 26 is permitted to drop downwardly partly under the action of gravity so as to be disposed in the desired displaced position.

At a location horizontally adjacent and to the side of the opening 24, the upper horizontal support surface 102 of the support part 100 has a raised surface provided by an elongate raised strip 146, typically composed of a friction material such as a rubber strip. When the moving glazing panel 26 is permitted to drop downwardly partly under the action of gravity so as to be disposed in the desired displaced position, the frame part 132 is supported on the strip 146 above the height of the support surface 102, so as to prevent the moving glazing panel 26 from dropping downwardly a sufficient distance to cause the opposed surfaces of the fixed and moving glazing panels 22, 26 inadvertently to contact each other. The raised strip 146 acts mutually to space apart the fixed and moving glazing panels 22, 26 in the displaced position. In addition, the raised strip 146 acts to retain, by friction between the adjacent surfaces of the frame part 132 and the raised strip 146, the moving glazing panel 26 in a desired displaced position, without inadvertent sliding motion, for example due to movement of the vehicle.

In the preferred embodiment, the raised strip 146 has a profiled surface, for example in the form of a wave or saw-tooth section along its length, and the frame 35 of the moving glazing panel 26 is correspondingly provided with a downwardly directed opposed strip 147, as shown in FIG. 4, which has a complementary profiled surface. When the moving glazing panel 26 is in the displaced position, the strips 146, 147 are pushed together by gravity and the complementary surfaces mesh together. This greatly increases the frictional resistance to inadvertent sliding movement of the moving glazing panel 26 away from the desired displaced position.

A particularly preferred construction for the handle 160 is shown in FIGS. 16 and 17.

A support body 800 is affixed to the inside face 86 of the moving glazing panel 26, either via the frame 162 or directly. The support body 800 includes a cam slot 802 that is oriented in an inclined manner along a major portion 803, typically substantially all, of its length at an acute angle to the horizontal, typically from 15 to 30 degrees to the horizontal. At an upper end 804 of the cam slot 802 is a horizontal slot portion 806. The handle 160 is affixed to the rod 164, and the rod 164 has affixed thereto a horizontally extending pin 808 which is received in the cam slot 802 and arranged for sliding movement therealong. The pin 808 and the cam slot 802 preferably have mutually engaging interlocking surfaces, such as trapezoid spiral or threaded surfaces. The handle 160, together with the rod 164 and pin 808 mounted thereto, is capable of vertical movement relative to the moving glazing panel 26.

In the closed configuration of the window, the pin 808 is received in the horizontal slot portion 806. Accordingly, any relative vertical movement between the pin 808 and the moving glazing panel 26, and consequently between the moving glazing panel 26 and the fixed glazing panel 22, is inhibited. The moving glazing panel 26 is locked in a closed position.

When it is desired to open the window by moving the moving glazing panel 26 inwardly and upwardly, the handle 160 is rotated about a vertical axis defined by the rod 164. This causes the pin 808 to be slid out of the horizontal slot portion 806, to an unlocked position, and then the pin 808 is slid downwardly along the major inclined portion 803 of the cam slot 802, the pin 808 and the can slot 802 being preferably mutually interlocked as aforesaid. FIG. 17 shows the relationship between the pin 808 and the slot 802 in a partly open position of the handle structure. This in turn permits the operator to lift the moving glazing panel 26 by lifting the handle 160 as the handle 160 continues to be rotated. Rotating the handle 160 causes the handle 160 to be lifted relative to fixed glazing panel 22 and lowered relative to moving glazing panel 26.

This lifting action also lifts the rotating rod 164 which, because the upper end of the rod 164 is fitted to the arm 82 via the tiltable joint 166, causes the arm 82 to rotate. This in turn permits the moving glazing panel 26 to move upwardly and inwardly to open the window. The continued rotation causes the pin 808 to move down the cam slot 802, which causes downward movement of the handle 160 relative to the moving glazing panel 26. However, the overall movement of the handle 160 during the opening operation is upward because of the upward movement of the rod 164 to which the handle 160 is affixed.

The window can be closed again in the reverse operation, by moving the handle 160 in the opposite rotational sense.

The first embodiment of the present invention is, in accordance with the first aspect of the invention, the structure of a particular sliding window for a vehicle. In the first embodiment, as described earlier, the upper and lower horizontal rails may be affixed to the bodywork of the vehicle at their ends, to provide a safety device supporting the moving glazing panel and its fittings in the event that the fixed glazing panel is broken.

In accordance with a further aspect of the present invention, six further embodiments of the invention are disclosed with respect to FIGS. 7 and 8, 9 and 10, 11 and 12, 13, 14 and 15 which disclose alternative safety devices for a movable glazing of a vehicle window. Such a movable glazing may be not only a sliding window, as for the first embodiment, but also a hinged window in which the moving glazing panel is openable by being articulated about a horizontal hinge axis. In both types of openable window, the safety device acts to support the moving glazing panel and the fittings for the moving glazing panel in the event of breakage of the fixed glazing panel.

Referring to FIGS. 7 and 8, a hinged window 204 for a vehicle in accordance with the second embodiment of the present invention comprises a fixed glazing panel 222 having an opening 224 therein in which a moving glazing panel 226 is fitted. The fixed glazing panel 222 surrounds the moving glazing panel 226. The moving glazing panel 226 is mounted along a lower horizontal edge 230 thereof to a horizontally oriented elongate hinge mechanism 232 which is connected at its opposed ends to upwardly directed hinge supports 240, 242. The hinge supports 240, 242 are disposed against, but not directly fixed to, the inside face 244, facing the interior of the vehicle, of the fixed glazing panel 222. If desired, the elongate hinge mechanism 232 may include a stationary portion which is correspondingly disposed against the inside face 244 of the fixed glazing panel 222 and fixed to the outside face by a support part having a hook-like mounting, similar to support part 100 having hook-like mounting 112 of the embodiment of FIGS. 1 to 6. The elongate hinge mechanism 232 and the hinge supports 240, 242 are spaced inwardly of the outer periphery 210 of the window 204 which is fitted within a recess 208 of the body 206 of the vehicle, for example a bus, in the same manner as that for the first embodiment.

A safety device 250 is provided between (a) the body 206 and (b) the interconnected elongate hinge mechanism 232 and hinge supports 240, 242. The safety device 250 comprises two pairs of extension members, each pair located at a respective horizontal end of the interconnected elongate hinge mechanism 232 and hinge supports 240, 242. A first extension member 252 of each pair is securely fixed to a respective end of the hinge mechanism 232 and the rear surface is bonded, for example by adhesive, to the inside face of the fixed glazing panel 222. The second extension member 254 is securely fixed to the body 6 (for example by being sandwiched between the fixed glazing panel 222 and the body 206) and similarly bonded to the fixed glazing panel 222. The first and second extension members 252, 254 extend towards each other and laterally overlap (by a distance L in FIG. 8, typically at least 5 mm), in a horizontal direction, but are mutually spaced by a small gap 256, preferably less than 3 nm, typically about 1 mm in width (distance G in FIG. 8), so that the two extension members do not physically connect each other, but rather are interconnected by a narrow band of the fixed glazing panel 222.

The fixed glazing panel 222 is typically made of toughened glass as a single pane, but alternatively may be made of a double glazed unit. The width G and length L of the band of glass between the first and second extension members 252, 254 are selected so as to be smaller than the typical glass fragment size following breakage of the fixed glazing panel 222. Accordingly, in the event that the fixed glazing panel 222 is broken, at least one glass fragment, and more preferably a plurality of glass fragments for enhanced stability, remains adhered to both of the first and second extension members 252, 254, to thereby straddle the gap between the first and second extension members 252, 254. This at least one glass fragment acts to ensure that even though the fixed glazing panel 222 is broken, the moving glazing panel 226 and its associated hinge mechanism 232 are nevertheless safely supported on the body 206 by the first and second extension members 252, 254 and the glass fragment(s) straddling the gap.

This embodiment has the advantage of easy assembly of the window incorporating the safety device into the vehicle. Also, the safety device is aesthetically attractive.

Referring to FIGS. 9 and 10, a hinged window 304 for a vehicle in accordance with the third embodiment of the present invention comprises a fixed glazing panel 322 having an opening 324 therein in which a moving glazing panel 326 is fitted. The fixed glazing panel 322 surrounds the moving glazing panel 326. The moving glazing panel 326 is mounted along a lower horizontal edge 330 thereof to a horizontally oriented elongate hinge mechanism 332 which is connected at its opposed ends to upwardly directed hinge supports 340, 342. The hinge supports 340, 342 are disposed against, but not directly fixed to, the inside face 344, facing the interior of the vehicle, of the fixed glazing panel 322. If desired, the elongate hinge mechanism 332 may include a stationary portion which is correspondingly disposed against the inside face 344 of the fixed glazing panel 322 and fixed to the outside face by a support part having a hook-like mounting, similar to support part 100 having hook-like mounting 112 of the embodiment of FIGS. 1 to 6. The elongate hinge mechanism 332 and the hinge supports 340, 342 are spaced inwardly of the outer periphery 310 of the window 304 which is fitted within a recess 308 of the body 306 of the vehicle, for example a bus, in the same manner as that for the first embodiment.

A safety device 350 is provided between (a) the body 306 and (b) the interconnected elongate hinge mechanism 332 and hinge supports 340, 342. The safety device 350 comprises at least one extension element 352, the or each extension element 352 being located at a respective upper end of a respective hinge support 240, 242. In the illustrated embodiment, only a single extension element 352 is provided associated with the hinge support 242.

The extension element 352 is securely fixed at its upper end 354 to the body 306 (for example by being sandwiched between the fixed glazing panel 322 and the body 306) and depends downwardly towards the hinge support 242. The rear surface of the extension element 352 is bonded, for example by adhesive, to the inside face of the fixed glazing panel 322. The lower end 354 of the extension element 352 has a hook device 356 depending downwardly therefrom. The hook device 356 is, in the illustrated embodiment, in the form of an inverted (i.e. upside down) letter T. The cross-piece 358 and a lower portion of the down piece 360 of the hook device 358 are slidingly received in a captive manner, and concealed, within a cavity 362 of the hinge support 342. Preferably, there is no physical contact between the hook device 358 and the hinge support 342.

As for the previous embodiment, the fixed glazing panel 322 is typically made of toughened glass as a single pane, but alternatively may be made of a double glazed unit.

In the event that the fixed glazing panel 322 is broken, if the moving glazing panel 326 and its associated hinge mechanism 332 and hinge supports 340, 342 start to fall under the action of gravity, they can fall only a small distance, typically a few millimetres, before the fall is arrested by capture of the hook device 358 within the cavity 362 of the hinge support 342. Accordingly, the moving glazing panel 326 and its associated hinge mechanism 332 and hinge supports 340, 342 are safely supported by the extension element 352 fixed to the body 306.

This embodiment has the advantage of easy assembly of the window incorporating the safety device into the vehicle. Also, the safety device is aesthetically attractive.

Referring to FIGS. 11 and 12, a hinged window 404 for a vehicle in accordance with the fourth embodiment of the present invention comprises a fixed glazing panel 422 having an opening 424 therein in which a moving glazing panel 426 is fitted. The fixed glazing panel 422 surrounds the moving glazing panel 426. The moving glazing panel 426 is mounted along a lower horizontal edge 430 thereof to a horizontally oriented elongate hinge mechanism 432 which is connected at its opposed ends to upwardly directed hinge supports 440, 442. The hinge supports 440, 442 are disposed against, but not directly fixed to, the inside face 444, facing the interior of the vehicle, of the fixed glazing panel 422. If desired, the elongate hinge mechanism 432 may include a stationary portion which is correspondingly disposed against the inside face 444 of the fixed glazing panel 422 and fixed to the outside face by a support part having a hook-like mounting, similar to support part 100 having hook-like mounting 112 of the embodiment of FIGS. 1 to 6. The elongate hinge mechanism 432 and the hinge supports 440, 442 are spaced inwardly of the outer periphery 410 of the window 404 which is fitted within a recess 408 of the body 406 of the vehicle, for example a bus, in the same manner as that for the first embodiment.

A safety device 450 is provided between (a) the body 406 and (b) the interconnected elongate hinge mechanism 432 and hinge supports 440, 442. The safety device 450 comprises two extending elements 452, 454, each extending element 452, 454 being located at a respective horizontal end of the interconnected elongate hinge mechanism 432 and hinge supports 440, 442. Each extending element 452, 454 is securely fixed at one end 458 to a respective end of the hinge mechanism 432 and at the other end 460 to the body 406. Each extending element 452, 454 is angled so the end 460 is bent back inwardly towards the interior of the vehicle and fixed to a side surface 462 of the body 406. Each extending element 452, 454 is composed of rubber or a metal, for example aluminium. If desired, the rear surface of each extending element 452, 454 is bonded, for example by adhesive, to the inside face of the fixed glazing panel 422.

Referring to FIG. 13, a hinged window 504 for a vehicle in accordance with a fifth embodiment of the present invention comprises a fixed glazing panel 522 having an opening 524 therein in which a moving glazing panel 526 is fitted. The fixed glazing panel 522 surrounds the moving glazing panel 526. The moving glazing panel 526 is mounted along a lower horizontal edge 530 thereof to a horizontally oriented elongate hinge mechanism 532 which is connected at its opposed ends to upwardly directed hinge supports 540, 542. The hinge supports 540, 542 are disposed against, but not directly fixed to, the inside face 544, facing the interior of the vehicle, of the fixed glazing panel 522. If desired, the elongate hinge mechanism 532 may include a stationary portion which is correspondingly disposed against the inside face 544 of the fixed glazing panel 522 and fixed to the outside face by a support part having a hook-like mounting, similar to support part 100 having hook-like mounting 112 of the embodiment of FIGS. 1 to 6. The elongate hinge mechanism 532 and the hinge supports 540, 542 are spaced inwardly of the outer periphery 510 of the window 504 which is fitted within a recess 508 of the body 506 of the vehicle, for example a bus, in the same manner as that for the first embodiment.

A safety device 550 is provided between (a) the body 506 and (b) the interconnected elongate hinge mechanism 532 and hinge supports 540, 542. The safety device 550 comprises two spring members 552, 554, each spring member 552, 554 being located at a respective horizontal end of the interconnected elongate hinge mechanism 532 and hinge supports 540, 542. Each spring member 552, 554 may comprise a helical compression spring, for example of metal, and may be enclosed within a respective housing 556, 558. Each spring member 552, 554 is securely fixed either at one end 560 to a respective end of the hinge mechanism 532 or at the other end 562 to the body 508, and in each case the opposite unfixed end 562, 560 is biased by the spring member 552, 554 against either the body 508 or the end of the hinge mechanism 532 respectively. The unfixed end 560, 562 may be received within a recess 564 in the form of a blind hole or biased against a friction contact pad, for example adhered to the underlying surface of the body 506 or elongate hinge mechanism 532, to assist the secure location of that end 560, 562 in the biased safety position.

In this way, the two spring members 552, 554 act to clamp the interconnected elongate hinge mechanism 532 and hinge supports 540, 542 within the recess 508 of the body 506 of the vehicle. If the fixed glazing panel 522 is broken, the spring members 552, 554 still support the interconnected elongate hinge mechanism 532 and hinge supports 540, 542, and the moving glazing panel 524 against falling out of the body 506.

To assemble window including the safety device 550, initially the spring members 552, 554 are compressed and then they are released after the interconnected elongate hinge mechanism 532 and hinge supports 540, 542, and the moving glazing panel 524 have been inserted into the recess 508 of the body 506 of the vehicle. This embodiment provides a safe and secure safety device at low cost that can readily be deployed in the assembly of the vehicle window. Also, the safety device is aesthetically attractive.

Referring to FIG. 14, a hinged window 604 for a vehicle in accordance with a sixth embodiment of the present invention comprises a fixed glazing panel 622 having an opening 624 therein in which a moving glazing panel 626 is fitted. The fixed glazing panel 622 surrounds the moving glazing panel 626. The moving glazing panel 626 is mounted along a lower horizontal edge 630 thereof to a horizontally oriented elongate hinge mechanism 632 which is connected at its opposed ends to upwardly directed hinge supports 640, 642. The hinge supports 640, 642 are disposed against, but not directly fixed to, the inside face 644, facing the interior of the vehicle, of the fixed glazing panel 622. If desired, the elongate hinge mechanism 632 may include a stationary portion which is correspondingly disposed against the inside face 644 of the fixed glazing panel 622 and fixed to the outside face by a support part having a hook-like mounting, similar to support part 100 having hook-like mounting 112 of the embodiment of FIGS. 1 to 6. The elongate hinge mechanism 632 and the hinge supports 640, 642 are spaced inwardly of the outer periphery 610 of the window 604 which is fitted within a recess 608 of the body 606 of the vehicle, for example a bus, in the same manner as that for the first embodiment.

A safety device 650 is provided between (a) the body 606 and (b) the interconnected elongate hinge mechanism 632 and hinge supports 640, 642. The safety device 650 comprises two bridge members 652, 654, each bridge member 652, 654 being located at a respective horizontal end of the interconnected elongate hinge mechanism 632 and the hinge supports 640, 642. Each bridge member 652, 654 is an extension of the sealing element 656 that surrounds the fixed glazing panel 622 and fixes the fixed glazing panel 622 within the recess 608. The sealing element 656, and the bridge members 652, 654, are composed of an adhesive bonding material, typically polyurethane. The ends 658, 660 of the bridge members 652, 654 are fitted by their adhesive properties to the elongate hinge mechanism 632, or to a mounting part 662 attached to the elongate hinge mechanism 632.

The two bridge members 652, 654 act to support the interconnected elongate hinge mechanism 632 and hinge supports 640, 642 within the recess 608 of the body 606 of the vehicle. If the fixed glazing panel 622 is broken, the adhesive bonded connections through the bridge members 652, 654 still support the interconnected elongate hinge mechanism 632 and hinge supports 640, 642, and the moving glazing panel 624 against falling out of the body 606.

This embodiment provides a safe and secure safety device at low cost that can readily be deployed in the assembly of the vehicle window. The bridge members, being integral with the sealing element 656 that surrounds the fixed glazing panel 622 and fixes the fixed glazing panel 622 within the recess 608, has minimal interference with other components of the window structure. Also, the safety device is aesthetically attractive.

Referring to FIG. 15, a hinged window 704 for a vehicle in accordance with a seventh embodiment of the present invention comprises a fixed glazing panel 722 having an opening 724 therein in which a moving glazing panel 726 is fitted. The fixed glazing panel 722 surrounds the moving glazing panel 726. The moving glazing panel 726 is mounted along a lower horizontal edge 730 thereof to a horizontally oriented elongate hinge mechanism 732 which is connected at its opposed ends to upwardly directed hinge supports 740, 742. The hinge supports 740, 742 are disposed against, but not directly fixed to, the inside face 744, facing the interior of the vehicle, of the fixed glazing panel 722. If desired, the elongate hinge mechanism 732 may include a stationary portion which is correspondingly disposed against the inside face 744 of the fixed glazing panel 722 and fixed to the outside face by a support part having a hook-like mounting, similar to support part 100 having hook-like mounting 112 of the embodiment of FIGS. 1 to 6. The elongate hinge mechanism 732 and the hinge supports 740, 742 are spaced inwardly of the outer periphery 710 of the window 704 which is fitted within a recess 708 of the body 706 of the vehicle, for example a bus, in the same manner as that for the first embodiment.

A safety device 750 is provided between (a) the body 706 and (b) the interconnected elongate hinge mechanism 732 and hinge supports 740, 742. The safety device 750 comprises a net 752 that is affixed to the inside face of the fixed glazing panel 722. The net 752 may be made of glass, plastic (e.g. polyamide, such as Kevlar) or metal fibres. The net 752 is affixed to the inside face of the fixed glazing panel 722 most preferably by being made integral with the fixed glazing panel 722, by being embedded in an obscuration layer 754. The obscuration layer 754 is composed of fired glass frit or ceramic paint that has been printed onto the inside face during manufacture of the fixed glazing panel 722. The obscuration layer 754 may visually conceal the net 752 therein.

The net 752 comprises two spaced portions 756, 758, each of which portions 756, 758 extends between a respective hinge support 740, 742 and the vehicle body 706. Each hinge support 740, 742 is affixed to the net 752, for example by being affixed to the inside face of the fixed glazing panel 722 so that a respective end of a net portion 756, 758 is sandwiched between the glass of the fixed glazing panel 722 and the respective hinge support 740, 742. In an alternative construction, the net could extend along the upper edge of the inside face of the fixed glazing panel 722 and the upper ends of the hinge supports 740, 742 could be affixed to the net 752.

If the fixed glazing panel 722 is broken, the net 752 retains the glass fragments thereunder together so that the net/glass fragment combination still supports the interconnected elongate hinge mechanism 732 and hinge supports 740, 742, and the moving glazing panel 724 against falling out of the vehicle body 706.

In a further alternative construction, the net could be replaced by a sheet of material, such as a sheet of metal such as aluminium, which is painted black to have the appearance of an obscuration layer or painted the same or a complementary colour as the interior of the vehicle, and affixed, for example by adhesive, to the inside face of the fixed glazing panel.

This embodiment provides a safe and secure safety device at low cost that can readily be deployed in the assembly of the vehicle window without additional steps being required during assembly. The net can be concealed in the obscuration band and so is visually attractive and has minimal interference with other components of the window structure.

In each of the embodiments of FIGS. 7 to 15, a hinged window is illustrated in which the safety device is disposed between the hinge mechanism and the body of the vehicle. However, but it should be apparent to those skilled in the art that each safety device may equally be employed for a sliding window, such as the sliding window of the first embodiment of FIGS. 1 to 6, in which the safety device is disposed between the slider rails and the body of the vehicle.

Also, in each of the embodiments of FIGS. 7 to 15 the moving mechanism is disposed adjacent to an inner face of the fixed glazing panel. As for the first embodiment, which includes the rail 38 and the hook-like mounting 112, in these further embodiments the moving mechanism may correspondingly include a horizontal rail that has a hook-like mounting, and the hook-like mounting extends through the opening and is fitted to the outer face of the fixed glazing panel at a location along a lower edge of the opening, the fitting of the hook-like mounting to the outer face of the fixed glazing panel supporting the moving glazing panel and the moving mechanism on the fixed glazing panel. This structure may be employed in any sliding or hinged window according to the invention, which may also include a safety device for supporting the moving glazing panel and the moving mechanism in the event of breakage of the fixed glazing panel.

It will be apparent to those skilled in the art that various modifications may be made to the disclosed embodiments without departing from the scope of the invention disclosed herein. Also, various features from the different embodiments may be combined or used interchangeably within the scope of the present invention.

1. A sliding window for a land vehicle, comprising a fixed glazing panel defining an opening therein, a moving glazing panel, an opening mechanism attached to the moving glazing panel for moving the moving glazing panel between a closed position, at which the moving glazing panel is received in the opening and substantially coplanar with the fixed glazing panel, and an open position, at which the moving glazing panel is laterally spaced inwardly relative to the opening, and a slider assembly, including upper and lower horizontal slider rails disposed along the inside face of the fixed glazing panel, for moving the moving glazing panel horizontally along the fixed glazing panel in spaced relation thereto between the open position and a displaced position, at which the moving glazing panel is longitudinally spaced relative to the opening, wherein the opening mechanism comprises an articulated mechanism connecting the upper edge of the moving glazing panel to the upper slider rail and a sliding mechanism connecting the lower edge of the moving glazing panel to the lower slider rail.

2. A sliding window according to claim 1 wherein the opening mechanism is adapted to raise the moving glazing panel as the moving glazing panel moves from the closed position to the open position.

3. A sliding window according to claim 1 wherein the articulated mechanism is adapted to cause the upper edge of the moving glazing panel to move about a non-circular arc when moving between the closed and open positions.

4. A sliding window according to claim 3 wherein the non-circular arc is relatively horizontal during the initial movement of the moving glazing panel from the closed to the open position and relatively vertical during the final movement of the moving glazing panel from the closed to the open position.

5. A sliding window according to claim 1 wherein the articulated mechanism comprises an articulated member having a first hinge at one end thereof connected to the upper slider rail and a second hinge at the other end thereof connected to the moving glazing panel.

6. A sliding window according to claim 5 wherein the first and second hinges are adapted to rotate in opposite rotational directions when moving between the closed and open positions.

7. A sliding window according to claim 5 further comprising a cover for the articulated mechanism, the cover being integral with the upper horizontal slider rail.

8. A sliding window according to claim 5 wherein the first hinge includes a first male hinge part integral with the upper horizontal slider rail received in a first female hinge part of the articulated member and the second hinge includes a second male hinge part of an arm, the arm being affixed to the moving glazing panel, received in a second female hinge part of the articulated member.

9. A sliding window according to claim 8 wherein the arm is attached to an upper mount that is bonded by adhesive to an upper elongate edge of the inside face of the moving glazing panel.

10. A sliding window according to claim 9 wherein the upper mount is part of a frame that extends around the periphery of the inside face of the moving glazing panel.

11. A sliding window according to claim 1 wherein the sliding mechanism is adapted to cause the lower edge of the moving glazing panel to move linearly when moving between the closed and open positions.

12. A sliding window according to claim 11 wherein the linear movement is at an angle of about 30 degrees to the horizontal.

13. A sliding window according to claim 1 wherein the sliding mechanism comprises a male part slidingly received within a female opening and in the open position the male part is received deeper into the female opening than in the closed position.

14. A sliding window according to claim 13 wherein the male part and the female extend horizontally along the lower edge of the moving glazing panel, and the female opening is downwardly oriented.

15. A sliding window according to claim 13 further comprising a cover for the sliding mechanism, the cover being connected to the male part.

16. A sliding window according to claim 15 wherein the cover for the sliding mechanism has an inner surface that is supported on a support part of the lower horizontal slider rail in the closed position.

17. A sliding window according to claim 16 wherein the cover for the sliding mechanism is attached to a lower mount that is bonded by adhesive to a lower elongate edge of the inside face of the moving glazing panel.

18. A sliding window according to claim 17 wherein the lower mount is part of a frame that extends around the periphery of the inside face of the moving glazing panel.

19. A sliding window according to claim 1 wherein the lower horizontal slider rail has a hook-like part that extends through the opening and is fitted to the outer face of the fixed glazing panel at a location along a lower edge of the opening.

20. A sliding window according to claim 1 further comprising a safety device for supporting the moving glazing panel and the slider assembly in the event of breakage of the fixed glazing panel, the safety device comprising a first connector fixed to the slider assembly and a second connector located at a periphery of the fixed glazing panel and adapted to be fixed to a body of the vehicle when the window is fitted into a recess in the body of the vehicle, the first and second connectors being cooperatively interconnected without direct physical contact therebetween.

21. A sliding window according to claim 20 wherein the first and second connectors are each bonded to a surface of the fixed glazing panel and are mutually spaced by a gap that is straddled by a portion of the fixed glazing panel.

22. A sliding window according to claim 21 wherein the gap has a width of less than 3 mm.

23. A sliding window according to claim 22 wherein the gap has a width of about 1 mm.

24. A sliding window according to claim 21 wherein the gap has a length of at least 5 mm.

25. A sliding window according to claim 20 wherein the first connector has a cavity and the second connector has an extension that is captive in the cavity.

26. A sliding window according to claim 1 further comprising a safety device for supporting the moving glazing panel and the slider assembly in the event of breakage of the fixed glazing panel, the safety device comprising at least one element connected between the slider assembly and a periphery of the fixed glazing panel and adapted to be fixed to a body of the vehicle when the window is fitted into a recess in the body of the vehicle.

27. A sliding window according to claim 26 wherein the at least one element comprises at least two spring members, each spring member being affixed to one of the slider assembly and the body and biased against the other of the slider assembly and the body whereby the slider assembly is clamped on opposed sides by spring bias applied by the spring members.

28. A sliding window according to claim 26 wherein the at least one element comprises at least two bridge members integral with a sealing element that surrounds the fixed glazing panel and fixes the fixed glazing panel within the recess.

29. A sliding window according to claim 26 wherein the at least one element comprises a planar member integral with or affixed to the inside face of the fixed glazing panel.

30. A sliding window according to claim 29 wherein the planar member comprises a net affixed to the inside face of the fixed glazing panel by an obscuration layer.

31. An openable window for a land vehicle, comprising a fixed glazing panel defining an opening therein, a moving glazing panel, a moving mechanism attached to the moving glazing panel, the moving glazing panel being movable by said moving mechanism between a closed position, at which the moving glazing panel is received in the opening and substantially coplanar with the fixed glazing panel, and an open position, and a safety device for supporting the moving glazing panel and the moving mechanism in the event of breakage of the fixed glazing panel, the safety device comprising a first connector fixed to the moving mechanism and a second connector located at a periphery of the fixed glazing panel and adapted to be fixed to a body of the vehicle when the window is fitted into a recess in the body of the vehicle, the first and second connectors being cooperatively interconnected.

32. An openable window according to claim 31 wherein the first and second connectors are cooperatively interconnected without direct physical contact therebetween.

33. An openable window according to claim 31 wherein the first and second connectors are each bonded to a surface of the fixed glazing panel and are mutually spaced by a gap that is straddled by a portion of the fixed glazing panel.

34. An openable window according to claim 33 wherein the gap has a width of less than 3 mm.

35. An openable window according to claim 34 wherein the gap has a width of about 1 mm.

36. An openable window according to claim 33 wherein the gap has a length of at least 5 mm.

37. An openable window according to claim 31 wherein the first connector has a cavity and the second connector has an extension that is captive in the cavity, are each bonded to a surface of the fixed glazing panel and are mutually spaced by a gap that is straddled by a portion of the fixed glazing panel.

38. An openable window according to claim 31 which is a hinged window.

39. An openable window according to claim 31 which is a sliding window.

40. A window for a land vehicle, comprising a fixed glazing panel defining an opening therein, a moving glazing panel, a moving mechanism attached to the moving glazing panel, the moving glazing panel being movable by said moving mechanism between a closed position, at which the moving glazing panel is received in the opening and substantially coplanar with the fixed glazing panel, and an open position, and a safety device for supporting the moving glazing panel and the slider assembly in the event of breakage of the fixed glazing panel, the safety device comprising at least one element connected between the moving mechanism and a periphery of the fixed glazing panel and adapted to be fixed to a body of the vehicle when the window is fitted into a recess in the body of the vehicle.

41. A window according to claim 40 wherein the at least one element comprises at least two spring members, each spring member being affixed to one of the moving mechanism and the body and biased against the other of the moving mechanism and the body whereby the moving mechanism is clamped on opposed sides by spring bias applied by the spring members.

42. A window according to claim 40 wherein the at least one element comprises at least two bridge members integral with a sealing element that surrounds the fixed glazing panel and fixes the fixed glazing panel within the recess.

43. A window according to claim 40 wherein the at least one element comprises a planar member integral with or affixed to the inside face of the fixed glazing panel.

44. A window according to claim 43 wherein the planar member comprises a net affixed to the inside face of the fixed glazing panel by an obscuration layer.

45. A window according to claim 40 which is a hinged window.

46. A window according to claim 40 which is a sliding window.

47. A window according to claim 31 wherein the moving mechanism is disposed adjacent to an inner face of the fixed glazing panel, the moving mechanism includes a horizontal rail that has a hook-like mounting, and the hook-like mounting extends through the opening and is fitted to the outer face of the fixed glazing panel at a location along a lower edge of the opening, the fitting of the hook-like mounting to the outer face of the fixed glazing panel supporting the moving glazing panel and the moving mechanism on the fixed glazing panel.
